(19) United States
(12) Patent Application Publication
(10) Pub. No.: US 2011/0194735 A1
(43) Pub. Date: Aug. 11, 2011

(54) AUTOMATIC REPAIR OF FLAT, TEXTURED OBJECTS, SUCH AS WOOD PANELS HAVING AESTHETIC RECONSTRUCTION

(75) Inventor: Robert Massen, Ohningen (DE)

(73) Assignee: BAUMER INNOTEC AG, Frauenfeld (CH)

(21) Appl. No.: 13/119,970

(22) PCT Filed: Sep. 3, 2009
(86) PCT No.: PCT/EP09/06390

§ 371 Date: Apr. 28, 2011

(30) Foreign Application Priority Data
Sep. 22, 2008 (DE) 10 2008 048 383.4

(51) Int. Cl. G06K 9/00

(52) U.S. Cl. 382/108

(57) ABSTRACT

The invention relates to an automatic system for repairing surfaces having natural patterns, particularly wood panels, wherein after the automatic detection and repair of the faulty regions by smoothing or doweling, the Visually apparent repair regions are decorated loudly by a numerically controlled decoration process, particularly an ink jet printing technology. To this end, the panel is captured optically by a scanner, which in particular can detect colors, in addition to an image generator suitable for detecting the faulty regions. From the global color and structure characteristics of the panel and the local color and structure characteristic of each individual faulty region, local decoration patterns to be applied automatically are derived, which allow the faulty region to not be apparent any longer and give the panel a desired aesthetic appearance both locally and globally.

Panels made of solid wood or with a natural wood surface are used in very large amounts in the flooring industry, in the furniture industry, and in architecture. Due to the high price of natural wood, these panels very often consist of a composite of fiberboards or of moderately priced woods and a relatively thin, visible layer of natural wood veneer or natural solid wood, which determines the aesthetic impression. Since the natural material wood always has numerous flaws, such as loose or rotten knotholes, medullary tubes that have been cut into, cracks, etc., these flaws must be locally repaired to guarantee good physical quality of the surface (evenness, impermeability, etc.).

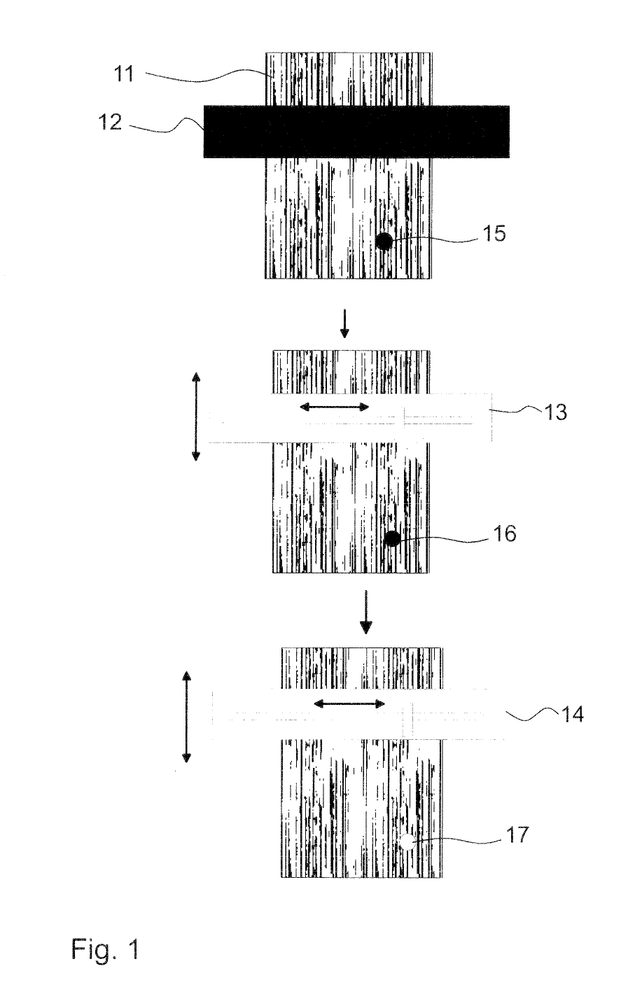

This process is still carried out manually in most wood panel production facilities. A large number of workers make a purely visual inspection of the surface of a panel, rout out the flaws, such as knotholes, medullary tubes, etc., with a manual tool, and repair these routed places by introducing a wood putty or by driving in a prefabricated wooden dowel. Sometimes these repair personnel have several wood putty colors available, so that they can select the color that comes closest to the basic color of the wood. Nevertheless, the aesthetic quality of the repaired place is very low compared to an area without flaws. As the image in FIG. 1 shows (which for reasons related to printing technology is limited to a pure graphic black-and-white reproduction), the wood putty introduced into a knothole remains annoyingly visible. The natural texture of the knothole has been replaced by a smooth, homogeneous wood putty surface. Even when a prefabricated dowel is inserted, the repair sites remain highly visible. Despite the very high labor input and the associated high costs for repairing the usually numerous flaws of a panel, the aesthetic quality of these panels, which have received only purely physical repair work, by far can no longer be compared with an unflawed panel, and therefore these panels suffer from a corresponding reduction of value.

Automatic repair systems have recently become commercially available, which consist of a combination of an image-processing system for detecting flaws on the wood panel and a subsequent robot-equipped installation for local routing and the introduction of wood putty or dowels.

The Norwegian company Argus Control SA (http://www.argoscontrol.no) offers an “Argos Panel Repair System”, which consists of an optical black-and-white scanner for the detection and localization of the flaws to be repaired and a numerically controlled xyz-axis system for routing and filling the flaws.

The company Baumer Inspection GmbH, Konstanz (http://www.baumerinspection.com) also offers automatic repair systems under the name ColourBrain®-Putty, which consist of a special multisensory scanner and an automatic routing and puttying system and dowel placement system.

Both of these systems are capable of lowering the costs and the amount of time consumed for the physical repair of panels with a wood surface compared to a purely manual approach. Yet in previously known systems, the repair sites remain visible due to the interruption of the surface texture.

Therefore, there is an economic and technical interest in an automatic wood panel repair system which is capable not only of repairing the physical quality of the wood panels by a repair procedure but also of producing an aesthetic quality of the repaired panels that comes as close as possible to that of a flawless panel.

This objective is achieved by the objects of the independent claims. Advantageous embodiments and refinements of the invention are specified in the respective dependent claims. In accordance with the invention, the objective is achieved by inspecting the panels that are to be automatically repaired by the following process steps:

1. With at least one image-generating scanner necessary for detecting the physical flaws, hereinafter referred to as a “flaw scanner”, the physical flaws in the panel are determined

2. With at least one additional, preferably color-capable, image-generating scanner, hereinafter referred to as an “aesthetic scanner” or “texture scanner”, methods of automatic image analysis use the total image of the panel to compute descriptive features for the overall aesthetic impression, especially for the color impression and the visual impression of the patterning or texture.

3. With the use of the position and shape information of the flaws that were acquired with the flaw scanner, image segments of the given flaws are obtained from the image of the aesthetic scanner, where these image segments comprise the flaws themselves and their immediate surroundings, and methods of automatic image analysis use these image segments to compute descriptive features for the local aesthetic impression.

4. After the repair of the physical flaws by automatic routing, introduction of wood putty or dowels, or other physical repair technologies, a decorating device that can be positioned numerically or under computer control and that can be electronically controlled image point by image point is used to individually decorate the region of each repaired flaw with the use of the features responsible for the overall aesthetic visual impression of the panel as well as the features responsible for the local aesthetic impression of the flaws in question in such a way that the panel gives a visual impression at the site of the repaired flaw that comes as near as possible to a flawless panel and/or that the total repaired panel gives a desired overall aesthetic impression produced by the choice of the local decorative patterns.

The invention thus makes available a method for the automatic repair of flaws, especially in naturally patterned surfaces, in which the local repair otherwise leaves behind a visually disturbing impression compared to the flawless surface, where here the flaw is repaired as inconspicuously as possible by reconstruction or imitation of the texture at the flaw.

In the process steps specified above, two image-generating scanners are provided. However, they can also be combined in a single scanner.

Described in a different way, in general, to carry out the method for the automatic repair of a textured surface of a flat object
the textured surface of the flat object, such as a panel, that is affected with at least one flaw is acquired by an image-generating scanner,
a computing unit is used to determine at least the location and preferably also the size and/or the shape of the flaw on the basis of the image data recorded with the image-generating scanner,
the flaw is repaired by means of a computer-controlled repair tool, for example, by introducing a wood putty, possibly after removal of material from the surface,
the texture of the surface is determined on the basis of the image data,
the computing unit is used to determine textured coloring that imitates the texture of the surface, and
the previously determined coloring that imitates the texture of the surface is applied to the repaired flaw with a decorating device under computer control.

A corresponding automatic repair unit for repairing flaws in textured surfaces of flat objects comprises the following devices for accomplishing this:
at least one image-generating scanner for recording a typically digital image of the textured surface,
a computing unit connected with the image-generating scanner, so that the image data of the image-generating scanner can be transmitted to the computing unit and analyzed by it, where the computing unit is equipped to determine at least the location and preferably also the size and/or the shape of a flaw from the image data it receives, to use the image data to determine the texture of the surface, especially in the area surrounding the flaw, and to determine textured coloring that imitates the texture of the surface,
an automatic repair device, which repairs the flaw and which is connected with and controlled by the computing unit on the basis of the location coordinates determined by the computing unit and possibly the data of the determined shape and/or size of the flaw,
a decorating device, which is also connected with the computing unit, so that it can apply the coloring that imitates the texture of the surface, as previously determined by the computing unit, to the repaired surface under the control of the computing unit.

The removal of surface material from the flaw can be accomplished, for example, by boring or routing. If the flaw is a purely color-related disturbance of the texture, it may be possible to cover the flaw without removing material in order merely to hide the flaw.

In a simple embodiment of the invention, for the computing unit to determine an image of the coloring to be applied to the flaw, a suitable region can be cloned from the image data of the texture.

Dot-matrix printers are especially suitable as part of the decorating unit for producing individual texturing. They produce a printed image by computer-controlled placement of individual image points. In this connection, drop-on-demand printers, such as inkjet printers, are especially well suited. A printer of this type can easily produce almost any desired texturing with individual computer control.

In an advantageous refinement of the invention, to achieve a repair that is as inconspicuous as possible or to achieve an imitation of the texture that is as realistic as possible, the computing unit is set up, in the determination of the textured coloration that imitates the texture of the surface, to continue texture elements into the repaired flaw. Thus, the pattern of the structural elements of adjacent intact surface regions is determined, and the coloration to be applied is computed in such a way, for example, in the form of image data, that this coloration contains texture elements that fit the texture elements that are present. In other words, incorporating the texture of the surface areas bordering on the flaw, the computing unit computes a texture within the flaw that extrapolates the neighboring texture.

There are various possibilities for accomplishing this. One simple possibility consists in cloning a reference image segment of the surface, preferably in the neighborhood of the flaw, and then matching it. To cause the structures of the texture and of the image segment to coincide as much as possible, the image segment can then be deformed in a suitable way. One-sided or two-sided stretching and compression, rotation, scaling and cropping are suitable for this purpose.

In another embodiment of the invention, a reference segment of the texture, i.e., for example, an image of part of the texture in an intact place on the surface is used to produce an imitation of the texture. Naturally, the reference segment can also be obtained on another surface with the proper texture and it can even be obtained synthetically. For a good imitation of the texture, it is advantageous only that the reference segment have a structuring that is typical for the texturing of the surface. An image of the texture is generated recursively in the following way: for a picture element that is to be redetermined, for example, in the form of an individual pixel or several pixels, a surrounding area of previously determined pixels is selected.

Then a picture element in the form of this surrounding area is sought in the reference segment, which corresponds in its color values as much as possible to the color values of the surrounding area of the picture element that is to be redetermined. For example, sums, preferably weighted sums of the color values of corresponding pixels can be compared with one another. If the deviation of the sums is less than a preset limit, the picture element in the reference segment is taken as valid. More generally, the picture element in the reference segment is found if its color values correspond to the color values of the surrounding area of the picture element that is to be redetermined to the extent that the deviation of the color values of corresponding pixels is less than a predetermined limit.

The picture element which in its local relation to the picture element to be redetermined corresponds to its associated surrounding area is now sought in the reference segment. The color values of this picture element are then entered in the texture image that is to be determined at the corresponding place relative to the surrounding area. The process is then repeated with a picture element that is preferably adjacent to the previously determined picture element. By repetition of these process steps, the picture is thus successively filled with color values.

This algorithm can also be used to extrapolate existing textures from the neighborhood of the flaw into the areas of the flaw. To this end, we start from image data that contain, besides the area of the flaw, neighboring areas with the still existing texture. In the determination of the color values of the area surrounding an image region to be redetermined, these texture regions are then integrated in the surrounding area, so that picture elements that match this texture still present beside the flaw are sought from the reference segment and entered in the image of the coloring to be applied.

The idea of the invention will now be explained on the basis of a typical flaw in a wood surface, namely, a knothole. This is merely an example and in no way limits the invention. This explanation will be given with reference to the accompanying drawings.

FIG. 1 shows process steps for repairing wood panels by means of an automatic repair system.

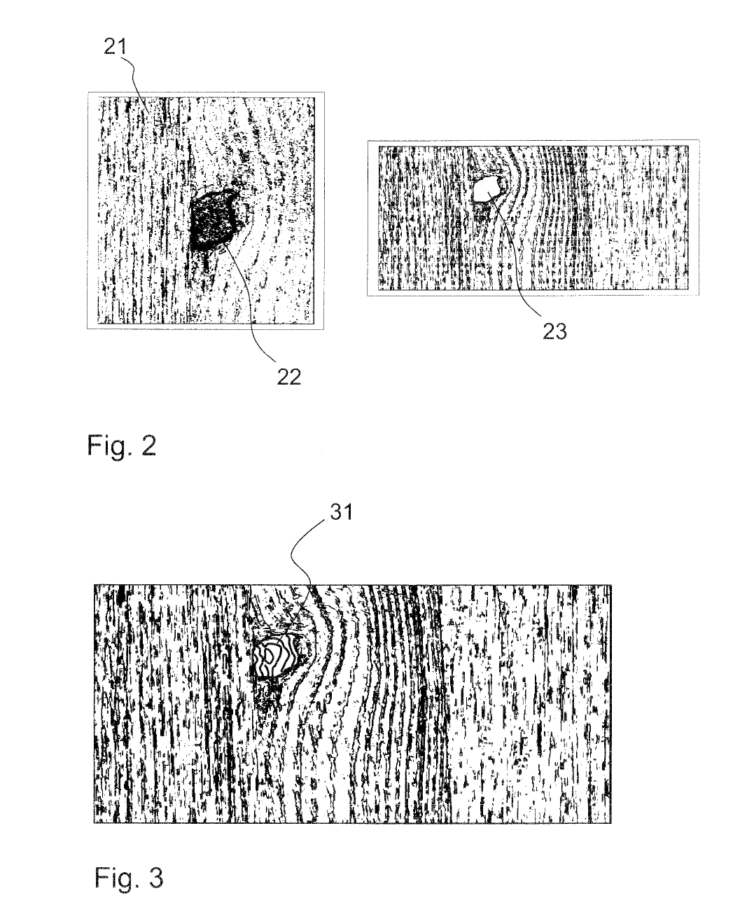

FIG. 2 shows a flawed wood surface.

FIG. 3 shows the flaw in the wood surface illustrated in FIG. 2 after the repair.

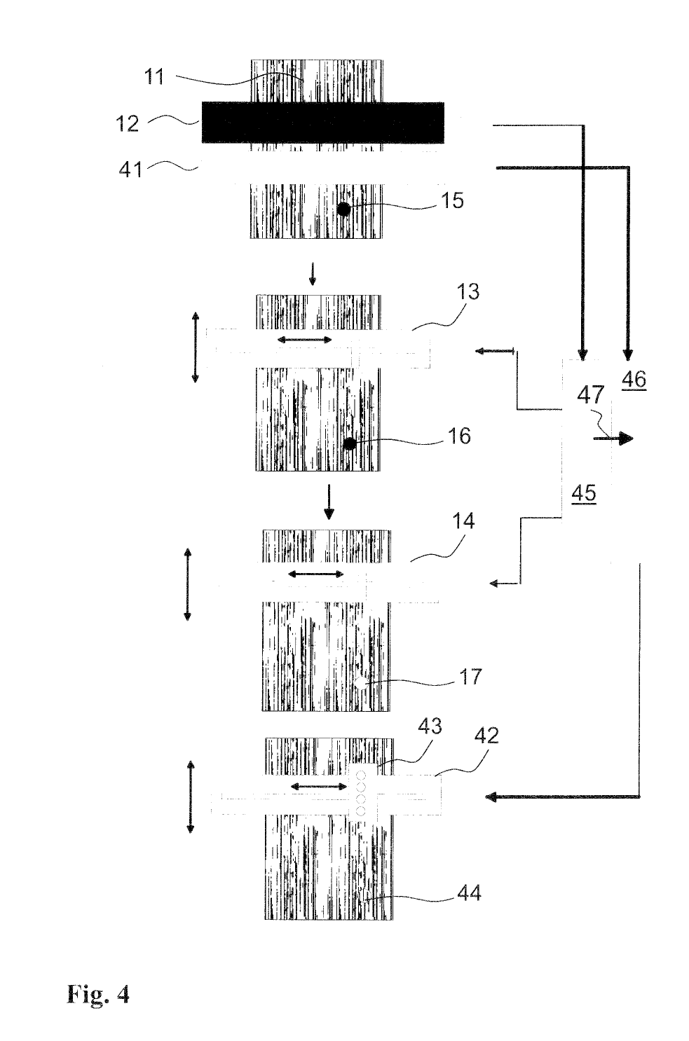

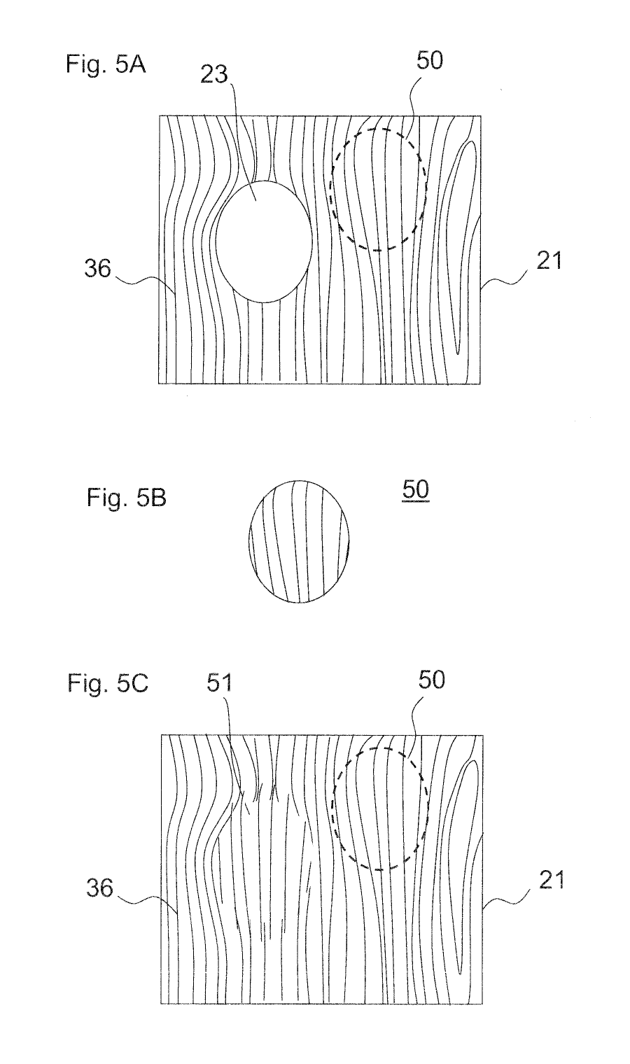

FIG. 4 shows process steps for repairing wood panels by means of an automatic repair system with aesthetic imitation of the surface texture.

FIGS. 5A to 5C show process steps for determining and applying coloring with texture elements on the flaw, which continue texture elements present in the neighborhood of the flaw.

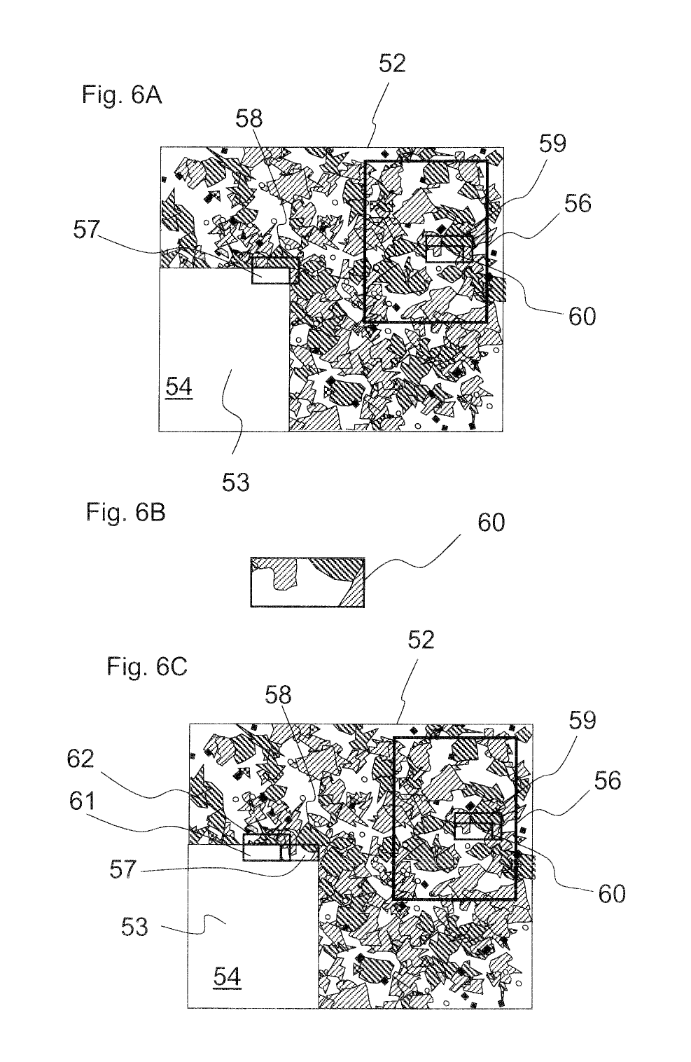

FIGS. 6A to 6C show process steps for imitating the grain of a stone plate in a repaired area, in which the texture is recursively supplemented by several smaller picture elements.

FIG. 1 shows, in a simplified way, a prior-art automatic repair system for natural wood surface panels 11, which comprises a black-and-white scanner 12 for detecting physical flaws 15 and measuring their position, a first Cartesian XYZ-manipulator 13 for moving a router to the flaws 16, and a second Cartesian XYZ-manipulator 14 for moving a putty injection tool to the flaw that has been routed out. With respect to the steps of the repair, a device of this type can also be used for the method of the invention, for example, as part of the device of the invention.

FIG. 2 shows a wood surface 21 with a rotten knothole that has fallen out before 22 and after 23 repair by filling and smoothing with wood putty. The flaw is seen as visually very conspicuous and disturbing due to the homogeneous, nonpatterned wood putty, even if the color of the wood putty is closely matched to the color of the wood surface.

FIG. 3 shows the flaw after decoration in accordance with the invention by reconstruction or imitation of the natural wood grain by means of an inkjet printer, shown simplified as black-and-white line graphics.

FIG. 4 shows an automatic repair system with the automatic aesthetic reconstruction for natural wood surface panels 11 in accordance with the invention, which comprises a black-and-white scanner 12 for detecting the flaws 15 and measuring their position, which transmits the raw image data to the image analyzer 45 for analysis, which uses image analysis to determine the information for controlling the first Cartesian XYZ-manipulator 13 for moving a router to the flaw and for routing out this flaw 16 and transmits the information for filling and smoothing the flaws that have been routed out to a second Cartesian XYZ-manipulator 14 to move a wood putty injection tool to the routed flaws 17, as well as a color-capable scanner 41 for acquiring the panel, which scanner 41 transmits the image data to an image analyzer 46 for determining both the global aesthetic features of the panel and the local aesthetic features in the region of each flaw, where the position and shape information of the flaws is transmitted from the analyzer 45 to the analyzer 46 via the data path 47, a third Cartesian XYZ-manipulator 42, which is controlled by the analyzer 46, for moving and controlling an inkjet printer head 43 for the local decoration of the given flaws.

In accordance with the prior art, as illustrated in FIG. 1, an achromatic image-generating scanner 12 is used to inspect a wood panel with a flaw to be repaired, which in the present example is a knothole. In the process, shape and position information about the flaw is determined and transmitted to a numerically positionable router 13. This positioning unit can be realized, for example, with a Cartesian XYZ-manipulator. The positions refer to a coordinate system associated with the panel, for example, with the left front corner as origin.

After the routing, the panel is moved into a second unit, in which a putty application head is numerically moved to the position of the routed flaw, which is then filled and smoothed.

The panels, which have an area of up to 8 m², generally contain numerous flaws. It is also possible to use swing arm robots instead of Cartesian positioning.

After the filling and smoothing operation, the entire surface of the panel is usually smoothed over and provided with a coat of transparent varnish.

As is illustrated in FIG. 2 with the example of a panel 21 with a dark knothole 22, this flaw is still annoyingly visible even after it has been filled and smoothed, since, even when the color has been specially selected, the smooth wood putty 23 has a smooth surface that contrasts sharply with the specific wood grain.

Therefore, in accordance with the invention, as shown by way of example in FIG. 3, a numerically positionable color-capable inkjet print head prints the smooth flaw with such a pattern and such a coloration that the natural texture of the area surrounding the flaw is continued over the flaw, and the color matches both the area surrounding the flaw and the overall color impression of the panel.

To this end, as is shown in FIG. 4, an automatic repair station according to the prior art is expanded by a computing unit with the following units: with an additional, usually color-capable, image generator 41, a color picture of the entire panel is prepared and transmitted to a analysis unit 46, and with an additional positioning unit 42, a numerically controllable decoration head, for example, a color-capable inkjet print head is guided to the smoothed flaws, where it prints a decorative pattern on the smooth locates that are causing visual disturbance. In this connection, the position information is transmitted from the analyzing computer 45, which analyzes the image signals of the scanner 12, to the decoration computer 46 via an internal or external data line 47.

Naturally, the printing operation is preferably carried out on the panel after it has been smoothed over following the filling of the flaws in order to obtain sharp and precise decorative patterns.

The determination of the decorative patterns follows two guidelines:

The overall aesthetic features, such as dominant color, color statistics, and the corresponding features of the wood grain, are determined from the total picture of the color-capable scanner. Experts in the inspection of natural wood are familiar with these types of methods. These features control the general color of the inkjet printer for the wood background and for the wood grain.

The local aesthetic features of the wood grain are determined from the segment image around each flaw, for example, local background color, colors of the grain in this place, the density, direction and curvature of the grain, etc.

It is possible to use a computer simulation to control these features by means of parameters, so that both a desired local impression and a desired overall impression of the wood panel are obtained.

If, for example, it is desired that the panel should give a rustic impression after the repair, then one might wish to decorate flaws in such a way that they imitate knotholes, resin galls or similar elements. If a fine-textured, high-quality panel is desired, then repaired knotholes would be decorated primarily in such a way that the natural grain is continued over the filled and smoothed flaw.

The method of the invention thus is not limited merely to the repair of panels in such a way that visually disturbing repaired flaws are no longer visible. The electronic monitoring of the decoration process makes it possible to control the overall appearance of the panel by suitable local decoration of the repaired flaws and thus to produce panels of high aesthetic quality from panels of low natural aesthetic quality. This is both an important economic advantage and an ecological advantage that allows better utilization of low-quality wood grades.

The recovery and production of these kinds of features are well known to experts in computer simulation. 3D simulation programs, such as 3D Studio Max or Alias Wavefront, now have available all texture generators, with which colored textures of natural materials, such as wood, can be simulated or extracted from existing images. They can be controlled in a variety of ways by means of parameters.

The numerically controllable decoration process of the invention is not limited to the use of inkjet printing technology. The idea of the invention also includes heat transfer printers and simple manipulators with a high temperature peak for local singeing of the wood surface. should appear here.

Therefore, the idea of the invention comprises the totality of all methods suitable for decorative alteration of a repaired flaw of a wood panel. It is obvious that this idea of the invention can be similarly applied to other natural products, such as natural stone, marble, etc.

The idea of the invention is not limited to repair by filling and smoothing or doweling. It includes all technologies for repairing local physical flaws in aesthetic surfaces, such as foaming, local removal, covering with a covering layer, etc.

The idea of the invention includes all image-generating scanners, such as matrix cameras and line cameras, spectrally selective cameras, flying-spot scanners, 3D scanners, and multisensory scanners, which supply an electronic image of the surface to be repaired.

The idea of the invention also includes scanners that are simultaneously capable of detecting flaws and obtaining the aesthetic features of the surface. Accordingly, the division of the scanner into two separate scanners, as shown in FIG. 4, is optional.

The idea of the invention also includes the additional local decoration of unflawed places with suitable patterns to furnish the panel with a desired appearance. For example, a less textured panel can be furnished with a rustic appearance by additional decoration with a knothole pattern or a resin gall design in less textured places, so that a new product can be produced.

FIGS. 5A to 5C show process steps for determining and applying coloring with texture elements on the flaw, which continue texture elements present in the neighborhood of the flaw.

FIG. 5A shows, first of all, a segment 23 of the surface of a wood panel 21 repaired with wood putty. The texture of the surface is determined by the growth zones of the wood grain with late wood lines 36. To determine a suitable textured coloring of the area filled with the wood putty, the computing unit now searches for a segment of the texture from the image data, and this segment is cloned for continuation of the texture. In other words, image data of the recording of an intact surface area is supplied to the decorating device, which then prints the color information of this area on the flaw.

FIG. 5B shows an image area of an intact texture of the panel 21. The same image area 50 appears in FIG. 5A surrounded by broken lines. This image area was selected for cloning and has the same size and shape as the filled flaw.

FIG. 5C shows the panel with the imprint 51 of the area 50 on the flaw by the decorating device. The area 50 was slightly stretched for the imprint and overlaps the texture adjacent to the flaw. An improved match can be obtained here by additionally rotating, compressing, stretching and/or cropping the area 50 in such a way that the best possible match with the neighboring texture is realized. To this end, for example, the line profiles at the edges of the neighboring texture and the edges of the area 50 can be matched to each other. In addition, the prominent texture elements of the surrounding texture, i.e., here the late wood lines 36, can additionally be partially covered by color, and the printed, imitated late wood lines can be softened towards the edge of the imprint 51, so that the actual lines and the printed lines make a smooth transition into each other.

Another possibility for imitating the grain in the repaired area is to supplement the texture by several smaller picture elements. FIGS. 6A to 6C show an example of a method of this type, in which recursively smaller image regions that match each other are supplemented.

First, a reference segment of the texture is again selected. Serving as an example here is a stone plate 52, for example, a granite plate. FIG. 6A shows a segment of the surface with a flaw 54 that has already been finished with filler 53. However, the method explained below can be similarly applied to other textures, for example, the grain of a wood panel.

First, a reference segment 56 of the texture is determined from the image data of the image-generating scanner.

A textured coloration that comes as close as possible to the texture of the reference segment 56 is then to be determined for the area 54 of the surface. For the sake of simplicity, the image of the color values to be determined, which are then transmitted to the decorating device, corresponds in size and shape to the region of the flaw 54 that has been smoothed with filler.

In addition, it would be desirable if the texture is not interrupted at the edge of the smoothed region. Therefore, the coloration should be such that the shape elements of the texture of the areas surrounding the filler extend continuously into the flaw.

The computing unit then determines the position of a picture element 57 to be redetermined and a surrounding area 58 that borders on the picture element 57. The picture element 57 is arranged at the edge of the flaw, so that parts of the intact texture are present in the surrounding area 58.

A picture element 59 in the form of this surrounding area 58 is then sought in the reference segment 56. This picture element 59 corresponds in its color values as closely as possible to the color values of the surrounding area 58 of the picture element 57 that is to be redetermined. With the picture element 59 found in this way, the position of a picture element 60 can now be determined. This picture element 60 has the same relative position to the picture element 59 as the picture element 57 that is to be redetermined has in relation to the surrounding area 58. In other words, the picture element 60 that corresponds in local relation to the picture element 57 to be redetermined relative to its associated surrounding area 58 is sought in the reference segment 56.

FIG. 6B shows an enlarged view of the picture element 60 thus found.

The color values of this picture element 60 are then entered in the texture image to be determined in the corresponding place with respect to the surrounding area, i.e., in picture element 57. This state is shown in FIG. 6C. After the color values of picture element 57 have been entered, the position of a further neighboring picture element 61 with surrounding area 62 is then determined. This surrounding area 62 now also contains parts of the imitated texture. As before with respect to picture element 57, a suitable surrounding area 59 is again sought in the reference segment 56, and the locally corresponding picture element 60 is determined, whose color values are then entered in picture element 61. This process is preferably repeated until the image provided for controlling the decorating device is filled with color values.

1-12. (canceled)

13. A method for the automatic repair of a textured surface of a flat object comprising:
acquiring an image of at least one flaw in the textured surface of the flat object with at least one image-generating scanner
determining the location and/or size and/or the shape of the flaw based on the image data recorded with the image-generating scanner,
repairing the flaw with a computer-controlled repair tool,
determining the texture of the surface on the basis of the image data,
determining a coloring that imitates the texture of the surface, and
applying the previously determined coloring that imitates the texture of the surface to the repaired flaw with a decorating device under computer control.

14. The method of claim 13, wherein the texture in the area of the flaw is determined on the basis of information acquired in the image, and the coloring that imitates the texture of the surface is determined, providing a texture that continues existing texture elements of the area surrounding the flaw.

15. A method for the automatic repair of a textured surface of a flat object comprising:
determining one or more flaws in the textured surface of a flat object with at least a first image-generating scanner necessary for detecting the physical flaws;
computing the descriptive features for the overall aesthetic impression of the textured surface including color impression and visual impression of the patterning with at least one additional color-capable image-generating scanner;
obtaining image segments of the flaws from the image of the additional scanner using the position and shape information of the flaws acquired with the first scanner, wherein said image segments comprise the flaws themselves and their immediate surroundings, and wherein said image segments are used to compute descriptive features of the local aesthetic impression;
repairing of the physical flaws using one or more physical repair technologies: and
individually decorating the region of each repaired flaw with a decorating device that can be positioned numerically and that can be electronically controlled image point to image point, wherein the features responsible for the overall aesthetic visual impression of the panel and the features responsible for the local aesthetic impression of the flaws in question are shown in such a way that the panel gives a visual impression at the site of the repaired flaw that comes as near as possible to a flawless panel and/or that the total repaired panel gives a desired overall aesthetic impression produced by the choice of the local decorative patterns.

16. The method of claim 13, wherein the surface to be repaired is selected from the group consisting of: natural wood surface and a natural stone surface.

17. The method of claim 13, wherein the coloring is applied by an inkjet printer that can be controlled image point by image point

18. The method of claim 13, wherein the determining of the coloring that imitates the texture of the surface, the computing unit continues texture elements into the repaired flaw, wherein the pattern of the structural elements of adjacent intact surface regions is determined, and wherein the coloration to be applied is computed so that it contains texture elements that fit the texture elements that are present.

19. The method of claim 13, wherein to achieve a desired overall aesthetic impression, both the flawed and unflawed areas are locally decorated.

20. The method of claim 13, wherein an image of the coloring to be applied to the flaw is determined by the computing unit by cloning a region from the image data of the texture.

21. The method of claim 13, further comprising:
determining a reference segment of the texture;
re-determining a picture element with one or more pixels by selecting a surrounding area of previously determined pixels;
locating a surrounding area in the reference segment, which corresponds in its color values to the color values of the surrounding area of the picture element that is to be re-determined to the extent that the deviation of the color values of corresponding pixels is less than a predetermined limit;
locating the picture element which in its local relation to the picture element to be re-determined corresponds to its associated surrounding area in the reference segment; and
entering the color values of the picture element in the texture image that is to be determined at the corresponding place relative to the surrounding area, wherein the computing unit recursively determines coloring that imitates the texture of the surface.

22. The method of claim 13, wherein existing textures are extrapolated from a neighboring region of the flaw to the areas of the flaw, wherein the process starts from image data that contain, besides the area of the flaw, the neighboring regions which still maintain the existing texture, and wherein the color values of the area surrounding an image region of coloring to be re-determined are integrated in the surrounding area, so that picture elements that match this texture still present beside the flaw are located from the reference segment and entered in the image of the coloring to be applied.

23. An automatic repair unit for repairing flaws in textured surfaces of flat objects, comprising:
at least one image-generating scanner for recording a typical digital image of the textured surface;
a computing unit connected with the image-generating scanner, configured so that the image data of the image-generating scanner can be transmitted to the computing unit and analyzed by it, wherein the computing unit is equipped to determine at least the location and/or the size and/or the shape of a flaw from the image data it receives, so that the image data may be used to determine the texture of the surface and to determine coloring that imitates the texture of the surface;
an automatic repair device for repairing the flaw which is connected with and controlled by the computing unit on the basis of the location coordinates determined by the computing unit; and
a decorating device, also connected to the computing unit, adapted for applying coloring that imitates the texture of the surface, as previously determined by the computing unit, to the repaired surface under the control of the computing unit.

24. The automatic repair unit of claim 23, wherein the surface to be automatically repaired is conveyed and treated by the following units:
(a) at least one image-generating scanner suitable for detecting flaws, which, together with a computing unit and an image analysis program, detects one or more flaws and determines their shape and position and the signals needed for making the automatic repairs;
(b) at least one additional image-generating scanner, which, together with the computing unit and an image analysis program, determines descriptive features for the overall aesthetic impression, including the visual impression of the patterning with automatic image analysis;
(c) a data transmission system for transmitting position and shape information of the flaws from the computing unit according to (a) to the computing unit according to (b);
(d) the automatic repair unit with at least one numerically positionable unit for repairing the flaws;
(e) the decorating device with at least one numerically positionable and electronically controllable decorating unit for decorating the repaired flaws with aesthetic patterns that were determined by the computing unit according to (b).
